(19) United States
(12) Patent Application Publication
(10) Pub. No.: US 2014/0297784 A1
(43) Pub. Date: Oct. 2, 2014

(54) Cross Platform Application Transactions

(71) Applicant: Lucy Ma Zhao, Austin, TX (US)

(72) Inventor: Lucy Ma Zhao, Austin, TX (US)

(21) Appl. No.: 13/853,463

(22) Filed: Mar. 29, 2013

(51) Int. Cl. H04L 29/08

(52) U.S. Cl. CPC H04L 67/10
USPC 709/217

(57) ABSTRACT

Systems and methods are provided for cross platform application transactions according to one or more embodiments. In an embodiment, a system comprises one or more processors and one or more memories adapted to store a plurality of machine-readable instructions which when executed by the one or more processors are adapted to cause the system to: receive an input comprising selection of an application for a transaction in connection with a recipient device, wherein the application is operable on one or more application platforms; receive identifier information of the recipient device; determine an application platform associated with the recipient device based at least in part on the identifier information of the recipient device; and present the application platform associated with the recipient device.

### BACKGROUND

1. Technical Field

Embodiments of the present disclosure generally relate to application platforms, and more particularly, to methods and systems for cross platform application transactions.

2. Related Art

Currently, applications may be downloaded or installed on user devices for various purposes in many contexts. Applications may be very useful and facilitate a user's device experience. However, applications today may be generally limited for use in specific platforms and/or may require a user to create a profile for each corresponding application platform when an application is purchased, for example, iTunes™ for Apple™, GooglePlay™ for Android™ or other applications for other platforms such as Blackberry™, games for specific PC platforms, etc.

### BRIEF DESCRIPTION OF THE FIGURES

FIG. 1 illustrates a system for conducting cross platform application transactions according to an embodiment of the present disclosure.

FIG. 2 is a flow diagram illustrating a method for a cross platform application transaction according to an embodiment of the present disclosure.

FIG. 3 is a diagram illustrating a flow for conducting a cross platform application transaction according to an embodiment of the present disclosure.

FIG. 4 is a block diagram illustrating a system for implementing a device according to one embodiment of the present disclosure.

Like element numbers in different figures represent the same or similar elements.

### DETAILED DESCRIPTION

In accordance with various embodiments described herein, methods and systems are provided for cross platform application transactions, for example, gifting of applications. In one or more embodiments herein, a user may select an application for gifting based at least in part on the platform used for running the application. For example, a user may want to gift to a friend a popular application that is highly-recommended. According to an embodiment, the user may select the popular application for gifting without having to worry about what user device platform the friend is using, for example, an iPhone™, Blackberry™, Android™, or the like. In that regard, based on, for example, certain user device identifiers, the appropriate user device platform may be determined such that the user may select to conduct a transaction, for example purchase and gift, the popular application for his or her friend's corresponding user device platform.

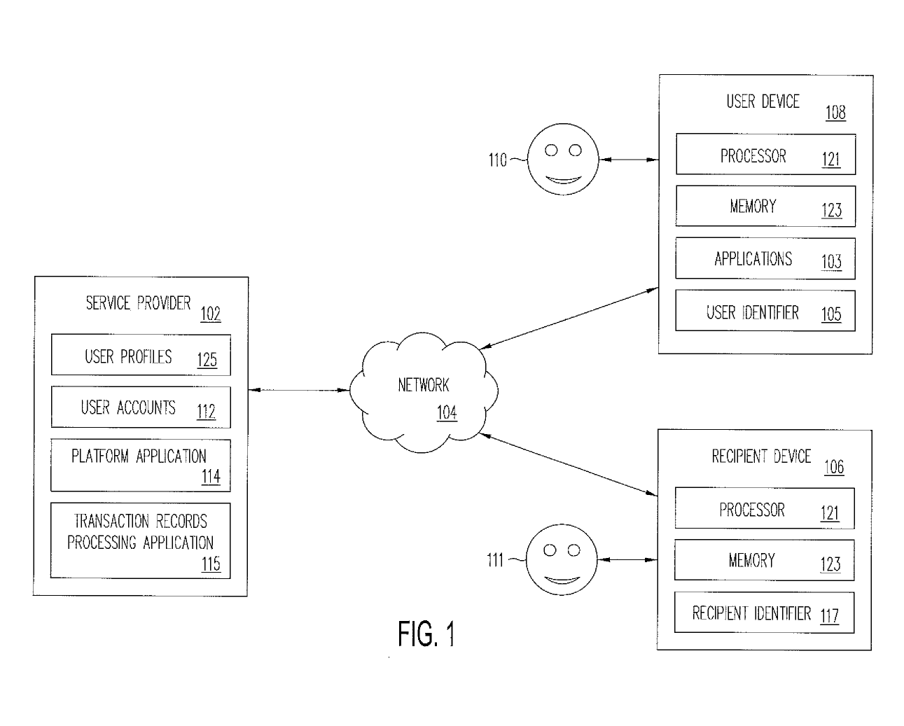

Referring now to the drawings wherein the showings are for purposes of illustrating embodiments of the present disclosure only, and not for purposes of limiting the same, FIG. 1 illustrates a system for conducting cross platform application transactions according to an embodiment of the present disclosure.

A service provider 102 is adapted to communicate or exchange data with a user device 108 and correspondingly a user 110 (also referred to as a “customer” or “consumer”), and a recipient device 106 and correspondingly a receiver 111 via a network 104. Data connections between service provider 102, user device 108 and recipient device 106 may take place, for example, via SMS or a Wireless Application Protocol (WAP) over network 104. In addition, according to one or more embodiments, service provider 102 may have other data connections (not shown), for example, with subscriber Internet companies, Internet financial companies, Internet brokers or other Internet companies. In one embodiment, service provider 102 may be implemented by a payment service provider such as PayPal™, Inc., or eBay™, Inc. of San Jose, Calif., USA.

User device 108 and recipient device 106 may each include one or more processors 121 coupled to one or more memories 123 configured to process downloading, installing and/or running of applications from one or more application developers. In general, user 110 or receiver 111 may download, install and/or run applications from one or more application developers involved with any context or purpose. Application developers may be any entity, for example an individual or a corporation that develops one or more portions of an application, for example a software application, operable on different types of user devices and/or application platforms. Examples of applications include iTunes™, which may run on an Apple™ platform (e.g., iPhone™), GooglePlay™, which may run on an Android™ platform, a RIM™ application store, which may run on a RIM™ platform (e.g., a Blackberry™ phone), games on a specific PC platform, or the like.

Advantageously, service provider 102 may implement a system for processing transactions such as facilitating the process of reviewing, selecting, purchasing and gifting applications. In that regard, when user 110 wants to gift an application to recipient 111, user 110 may easily gift the application without having to worry about what recipient device 106 application platform recipient 111 is using.

Service provider 102 may maintain a plurality of user accounts 112, each of which may include account information associated with specific users such as individuals, respectively. For example, in one embodiment, account information may include private or confidential information of a user such as account numbers, passwords, credit/debit card information, bank information, or other information that may be used to facilitate online or other types of transactions between service provider 102 and users (e.g., user 110 via user device 108).

According to an embodiment, platform application 114 of service provider 102 may be configured to interact with a user such as user 110 {via user device 108) so that user device 108 is enabled to download applications (e.g. in Applications 103) from service provider 102. A user may first register, sign up, or otherwise download a cross platform application from service provider 102 via platform application 114 in order to conduct a transaction such as gifting according to one or more embodiments of the present disclosure. In this regard, service provider 102 (or any other appropriate entity) may create and/or deploy an application such as a software application in a manner which is compatible with user device 108.

Service provider 102 may provide a transaction records processing application 115 that may be configured to receive transaction information from a user, for example, user 110 via user device 108 over network 104 and store the transaction information in a plurality of transaction records that are associated with individual user accounts 112. Also, transaction records may be implemented to store transaction information associated with particular applications, for example online, NFC or other types of downloaded applications, between user device 108 or user 110 and recipient device 106 or recipient 111.

Access to application transaction records may be controlled by service provider 102, for example, to prevent the storage or retrieval of the transaction records by other parties without the permission of user 110. In this regard, service provider 102 may require the receipt of a security identifier such as a valid password, a user identifier, a username, and/or other appropriate information before transaction records may be stored, changed, and/or retrieved.

It will be appreciated that by performing a plurality of transactions by a user such as user 110, a plurality of transaction records may be stored by service provider 102 and associated with an appropriate user account 112, which is associated with user 110.

User device 108 and recipient device 106 may be implemented using any appropriate combination of hardware and/or software configured for wired and/or wireless communication over a network. For example, in one embodiment, user device 108 and/or recipient device 106 may be implemented as a mobile device of user 110 or recipient 111, respectively, in communication with network 104 such as the Internet or another network. In other embodiments, user device 108 and/or recipient device 106 may be implemented as a tablet, personal computer, wireless telephone, personal digital assistant (PDA), key fob, smart phone, smart card, notebook computer, game console, digital video recorder (DVR), and/or other types of computing devices. Furthermore, user device 108 and recipient device 106 may be enabled for NFC, Bluetooth, online, infrared communications and/or other types of communications.

User device 108 and recipient device 106 may include various applications as may be desired in particular embodiments to provide desired features to user device 108 and recipient device 106, respectively. For example, in various embodiments, applications may include security applications for implementing client-side security features, programmatic client applications for interfacing with appropriate application programming interfaces (APIs) over a network, or other types of applications.

User device 108 and recipient device 106 may further include one or more user identifiers 105 or recipient identifiers 117, respectively, which may be implemented, for example, as operating system registry entries, cookies associated with a browser application, identifiers associated with hardware of user device 108 or recipient device 106, respectively, or other appropriate identifiers. In one embodiment, a user identifier such as user identifier 105 may be used by service provider 102 to associate user device 108 or user 110 with a particular account maintained by service provider 102. In another embodiment, recipient identifier 117 may be used by service provider 102 to associate recipient device 106 or recipient 111 with a particular account maintained by service provider 102.

User device 108, recipient device 106, and service provider 102 may each include one or more processors, memories, and other appropriate components for executing instructions such as program code and/or data stored on one or more computer readable mediums to implement the various applications, data, and methods described herein. For example, such instructions may be stored in one or more computer readable mediums such as memories or data storage devices internal and/or external to various components of the system, and/or accessible over a network, which may be implemented as a single network or a combination of multiple networks. For example, in various embodiments, network 104 may include the Internet or one or more intranets, landline networks, wireless networks, and/or other appropriate types of networks.

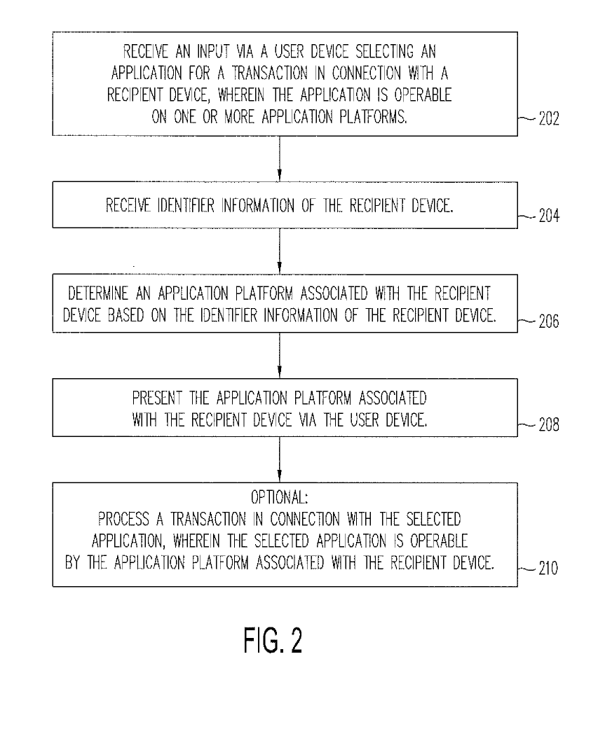

FIG. 2 is a flow diagram illustrating a method for a cross platform application transaction according to an embodiment of the present disclosure. It should be noted that the method of FIG. 2 may be implemented by the system of FIG. 1 according to an embodiment.

In block 202, inputs from a user via a user device may be received selecting an application for a transaction in connection with a recipient device such as gifting the application to a recipient via a recipient device, wherein the application is operable on one or more application platforms.

In an embodiment, service provider 102, an application provider entity or any other appropriate entity may provide an application that may be downloaded by a user device. For example, a user device 108 may download an application from platform application 114 of service provider 102 illustrated in FIG. 1 according to an embodiment. In that regard, service provider 102 may receive registration information from user 110 using user device 106 to open a user account 112. It should be appreciated that user 110 may provide account information to service provider 102 over network 104 through, for example, a secure connection between user device 108 and service provider 102. For example, in one embodiment, service provider 102 may provide a webpage that may be viewed by a user through a browser application.

As a result of such registration, service provider 102 may assign, and user device 108 may store, a specific user identifier 105 that may be used to identify the particular user as having a user account 112 maintained by service provider 102. The user identifier may be implemented, for example, as one or more cookies, operating system registry entries, hardware identifiers, or other types of identifiers. Other data specific to the user may be created and stored by service provider 102, including for example, signature information and a user profile 125. User profile 125 may be created, for example, based on a user's typical behavior in transactions. Furthermore, user data included in user device 108, for example, contact lists, calendar, etc., may be stored in memory 123 of user device 108 and/or by service provider 102, for example, in user profile 125. In an example, user data such as contact lists that may include type of device such as type of cell phone or phone model of a listed contact may be received from a communications service provider such as a cell phone provider and stored by service provider 102 or in memory 123 of user device 108. In other examples, user data of user device 108 such as contents of contact lists, calendar, etc., may be extracted via software tools. In further examples, a user may input data or information directly into his or her device as may be appropriate, for example, a user may input the type of device or platform that a contact is using; for instance, the user may input information for his or her social network, or in an example, if the user knows that a friend is using an iPhone™, then the user may input that information into his or her contact list. In yet another example, a recipient's device or platform, e.g., phone model, may also be determined via the device's IMEI or other identifiers specifically associated with a device or platform.

User 110 may download a cross platform application for conducting transactions such as gifting on user device 108. According to an embodiment, user 110 may download the cross platform application from platform application 114 of service provider 102 via network 104 as illustrated in FIG. 1.

Once user 110 downloads or installs the cross platform application onto user device 108 (e.g. in Applications 103), the user may conduct transactions such that the user may gift popular applications to friends or recipients without having to worry about the recipient device platforms that the friends are using.

When user 110 wants to gift an application to a recipient via a recipient device, the user may select an application that may be operable on one or more application platforms. In an embodiment, a popular application may only be compatible on certain platforms such as an Apple™ platform. In general, a user may not necessarily know whether a friend's user device (e.g. smart phone) platform may support a selected application.

In block 204, identifier information of the recipient device may be received. For example, once user 110 selects a particular application that is operable on one or more application platforms, a recipient's identifier may be obtained, for example, by user 110 selecting a particular recipient from the user's contact list. In that regard, the recipient's identifier may be for example the recipient's cell phone number, which may be included in the user's contact list.

In block 206, an application platform associated with the recipient device may be determined based on the identifier information of the recipient device as described above according to one or more embodiments. Based on a particular recipient's identifier (e.g., the particular recipient's cell phone number, which may be included in the user's contact list, the device's IMEI number, etc.), the recipient's phone platform may be determined. In an example, certain phone numbers may be associated with certain phone models or platforms, e.g. certain phone numbers may correspond to iPhones™, other phone numbers may correspond to Blackberries™, etc.

In block 208, the application platform associated with the recipient device may be presented. For example, a recipient device platform may be determined and shown or displayed to user 110 on user device 108. Conveniently, user 110 may determine which application platform supports an application that user 110 wants to gift to the recipient friend.

In block 210, optionally, a transaction may be processed in connection with the selected application, wherein the selected application is operable by the application platform associated with the recipient device. As such, user 110 may decide to purchase via user device 108 a popular application for gifting to a recipient that is operable on the recipient's user device platform. User 110 does not have to worry about the recipient device platform that the recipient is using.

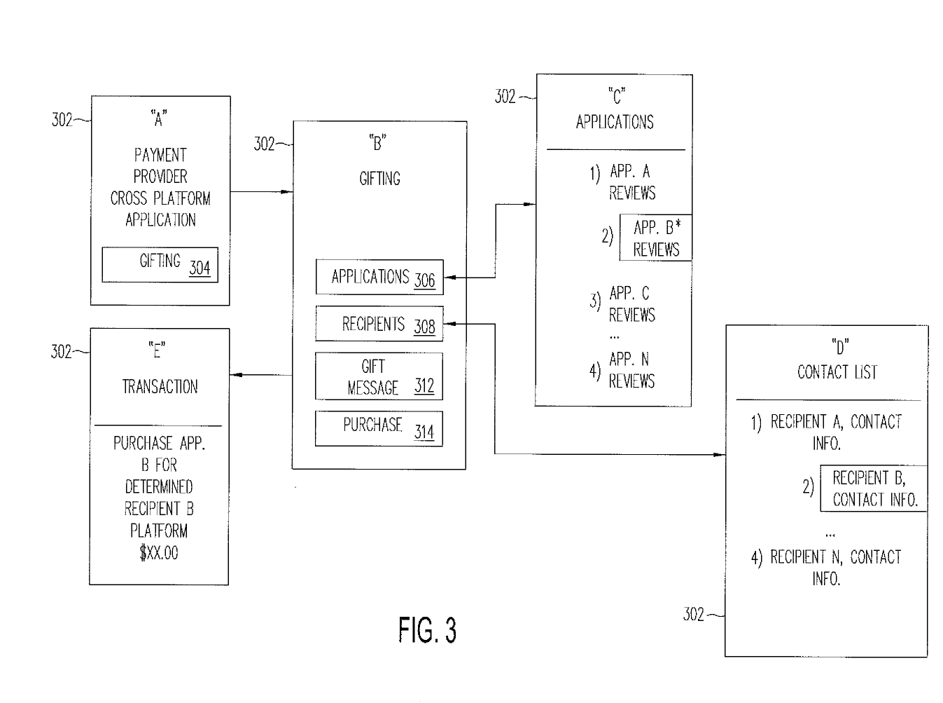

FIG. 3 is a diagram illustrating a flow for conducting a cross platform application transaction according to an embodiment of the present disclosure.

According to an embodiment, a user of a user device 302 may want to give a friend or recipient a highly rated, popular application. For example, Sam wants to give his niece Mandy the latest and greatest Dress-Up Doll application available. As illustrated on screen view “A” of user device 302, Sam may have downloaded a payment provider cross platform application from a service provider. It should be noted that a cross platform application according to one or more embodiments may be provided by any entity such as a payment provider, a merchant, an application developer or any other appropriate entity. In this embodiment, the payment provider cross platform application may be implemented by a system such that when a user opens the application, a “Gifting” interface 304 may be provided as illustrated in Screen view “A”. “Gifting” interface 304 may be implemented by any appropriate user interface including for example a tab, a touch button, a link, etc., and may have any appropriate label. Here, Sam selects “Gifting” interface 304 once he opens the cross platform application.

Screen view “B”, which appears upon selection of “Gifting” interface 304 on screen view “A”, may present several gifting options including an “Applications” interface 306, a “Recipients” interface 308, a “Gift Message” interface 312 and/or a “Purchase” interface 314. It should be understood that there may be various interfaces such as tabs, touch buttons, links, etc., presented as appropriate for the application and each interface may be implemented and/or labeled in any appropriate form that is compatible with user device 302. Here, Sam may select the “Applications” interface 306.

Screen view “C”, which may appear upon selection of “Applications” interface 306, shows or displays a list of applications. In that regard, the list of applications may be searched for specific types of applications, for example, for Doll Dress-Up applications. In this example, Sam may click to view reviews of the applications displayed and may select the most highly recommended Doll Dress-Up application on the list. Upon viewing the reviews, Sam may decide to select App. B as illustrated in screen view “C”.

Once an application has been selected, the system may go back to “Gifting” screen view “B” where the user may select a recipient for the selected application. The user may select “Recipients” interface 308, which may lead to the user's contact list (screen view “D”). In that regard, the contact list may show one or more contacts (also referred to as “Recipients”) along with respective contact information. The contact information may include recipient identifiers such as name, address, phone number, email address, etc. The user may then select a recipient such as Recipient B. For example, in “Gifting” screen view “B”, Sam may select Recipients interface 308, and then select his niece Mandy as a recipient from his contact list in screen view “D”.

The system, based on the selected Recipient's contact information including an identifier, may determine an application platform that the recipient is using. For example, based on Mandy's cell phone number, the system may determine the phone platform that she is using. In this example, the system may determine that Mandy uses an iPhone™ platform, As described above according to one or more embodiments, there may be various ways to determine an application platform that the recipient is using. For example, the system may store or have access to data such as corresponding type of cell phone or phone model for a listed contact such as Mandy, which may be received from a cell phone provider. In another example, the system may extract user data such as contents of contact lists (e.g., Mandy's phone number/type of phone), calendar, etc., via software tools. In a further example, the system may directly receive input data or information from a user as may be appropriate, for example, Sam may know that Mandy uses an iPhone™ and may input such information into his contact list associated with Mandy's contact information. In yet another example, Mandy's device or platform, e.g., phone model, may also be determined via the device's IMEI or other identifiers specifically associated with a device or platform.

Back to screen view “B”, optionally, the user may include a Gift Message via interface 312. The user may then select to proceed with a transaction by selecting “Purchase” interface 314 such that the system goes to screen view “E”.

In screen view “E”, the user may confirm the transaction in connection with a selected application for a particular application platform. Once the system determines the application platform that the recipient is using, the user may purchase the application for that application platform. For example, Sam may purchase a Dress-Up Doll application (App. B) for Mandy's iPhone™ platform. Conveniently, in one or more embodiments, the payment provider may be used in connection with payment for the selected application. As such, Sam may review applications, select an application, purchase the application and gift the application through the payment provider cross platform application.

Furthermore, the system may generate a communication such as a text message, an email, etc. to the recipient's device regarding the transaction. For example, a text alert may be generated to Mandy's cell phone regarding Sam's gift. Mandy may receive the communication, e.g., text alert, with a list to download her new application and a nice gift message from her favorite uncle Sam.

In various embodiments, the cross platform application may be implemented in platform application 114 of service provider 102 and may be downloaded onto Applications 103 of user device 108 as described above. The cross platform application may locate the contact list installed in user device 108 and query the identifier information of each particular contact including, for example, the phone number of each contact, or other types of identifiers.

Service provider 102 may compile identifier information corresponding to particular platforms. Service provider 102 may compare such compiled identifier information with identifier information as installed in user device 108 and as queried by the cross platform application to associate the identifier information installed in user device 108 with a particular corresponding platform as maintained by service provider 102.

Although various components and steps have been described herein as being associated with user device 108, recipient device 106, and service provider 102 of FIG. 1, it is contemplated that the various aspects of such servers illustrated in FIG. 1 may be distributed among a plurality of servers, devices, and/or other entities. For example, in one embodiment, transaction record processing application 115 may be implemented by an entity separate from service provider 102. Accordingly, in such an embodiment, communications described herein performed in relation to transaction record processing application 115 may be provided to a separate entity and need not be routed through service provider 102 in all instances.

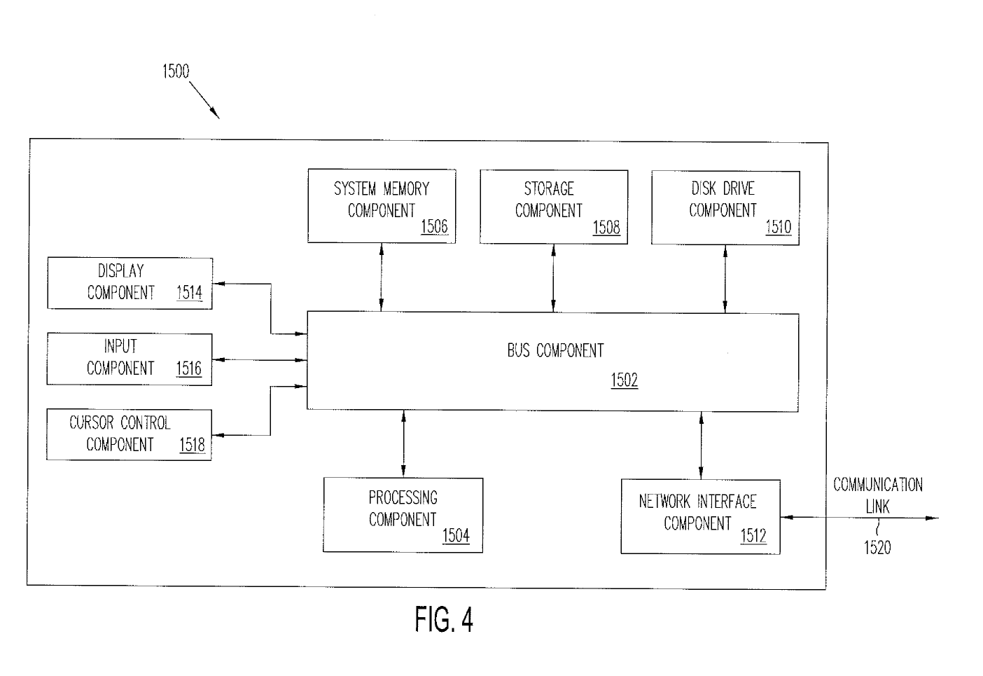

Referring now to FIG. 4, a block diagram of a system for implementing a device is illustrated according to one embodiment of the present disclosure.

FIG. 4 is a block diagram of a system 1500 suitable for implementing embodiments of the present disclosure, including user device 108 or 302, recipient device 106, and service provider 102 server or device. System 1500, such as part of a mobile phone, personal computer and/or a network server, includes a bus 1502 or other communication mechanism for communicating information, which interconnects subsystems and components, including one or more of a processing component 1504 (e.g., processor, micro-controller, digital signal processor (DSP), etc.), a system memory component 1506 (e.g., RAM), a static storage component 1508 (e.g., ROM), a network interface component 1512, a display component 1514 (or alternatively, an interface to an external display), an input component 1516 (e.g., touchpad, keypad or keyboard), and a cursor control component 1518 (e.g., a mouse pad).

In accordance with embodiments of the present disclosure, system 1500 performs specific operations by processor 1504 executing one or more sequences of one or more instructions contained in system memory component 1506. Such instructions may be read into system memory component 1506 from another computer readable medium, such as static storage component 1508. These may include instructions to create accounts, process applications, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1504 for execution. Such a medium may take many forms, including but not limited to, non-volatile media, volatile media, and transmission media. In various implementations, volatile media includes dynamic memory, such as system memory component 1506, and transmission media includes coaxial cables, copper wire, and fiber optics, including wires that comprise bus 1502. Memory may be used to store visual representations of the different options for application processing, payments, financial transactions or other transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1500. In various other embodiments, a plurality of systems 1500 coupled by communication link 1520 (e.g., network 104 of FIG. 1, LAN, WLAN, PTSN, or various other wired or wireless networks) may perform instruction sequences to practice the disclosure in coordination with one another. Computer system 1500 may transmit and receive messages, data, information and instructions, including one or more programs (i.e., application code) through communication link 1520 and communication interface 1512. Received program code may be executed by processor 1504 as received and/or stored in disk drive component 1510 or some other non-volatile storage component for execution.

Where applicable, various embodiments provided by the present disclosure may be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise fowls or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure. Thus the disclosure is limited only by the claims.

What is claimed is:

1. A system comprising:
one or more processors; and
one or more memories adapted to store a plurality of machine-readable instructions which when executed by the one or more processors are adapted to cause the system to:
receive an input comprising selection of an application for a transaction in connection with a recipient device, wherein the application is operable on one or more application platforms;
receive identifier information of the recipient device;
determine an application platform associated with the recipient device based at least in part on the identifier information of the recipient device; and
present the application platform associated with the recipient device.

2. The system of claim 1, wherein the plurality of machine-readable instruction which when executed by the one or more processors further cause the system to: process a transaction in connection with a selected application, wherein the selected application is operable on the application platform associated with the recipient device.

3. The system of claim 1, wherein the plurality of machine-readable instruction which when executed by the one or more processors further cause the system to: determine the identifier information of the recipient device based on user data.

4. The system of claim 3, wherein the user data further comprises at least one of a calendar and a contact list comprising at least one of a name, an address, a phone number, a type of device or device model, and an email of a recipient associated with the recipient device.

5. The system of claim 4, wherein the plurality of machine-readable instructions which when executed by the one or more processors further cause the system to: receive the type of device or device model from a communications service provider.

6. The system of claim 3, wherein the plurality of machine-readable instructions which when executed by the one or more processors further cause the system to: extract the user data via software tools.

7. The system of claim 3, wherein the plurality of machine-readable instructions which when executed by the one or more processors further cause the system to: directly receive user inputs comprising the user data

8. The system of claim 7, wherein the directly received user inputs further comprise a type of device or platform of the recipient device.

9. The system of claim 1, wherein the identifier information further comprises a phone number, an IMEI number, or an identifier specifically associated with the recipient device.

10. The system of claim 1, wherein the plurality of machine-readable instruction which when executed by the one or more processors further cause the system to: compare the received identifier information of the recipient device with application platform data maintained at a service provided server.

11. The system of claim 1, wherein the plurality of machine-readable instructions which when executed by the one or more processors are adapted to cause the system to:
download a cross platform application;
locate stored data associated with the recipient device; and
identify and show a device application platform of the recipient device based on the stored data.

12. The system of claim 1, wherein the plurality of machine-readable instructions which when executed by the one or more processors are adapted to cause the system to: generate a communication to the recipient device regarding a transaction in connection with a selected application.

13. A method comprising:
receiving, electronically by a processor, an input comprising selection of an application for a transaction in connection with a recipient device, wherein the application is operable on one or more application platforms;
receiving, electronically by the processor, identifier information of the recipient device;
determining, electronically by the processor, an application platform associated with the recipient device based at least in part on the identifier information of the recipient device; and
presenting the application platform associated with the recipient device.

14. The method of claim 13, further comprising processing a transaction in connection with a selected application, wherein the selected application is operable on the application platform associated with the recipient device.

15. The method of claim 13, further comprising determining the identifier information of the recipient device based on user data.

16. The method of claim 15, wherein the user data further comprises at least one of a calendar and a contact list comprising at least one of a name, an address, a phone number, a type of device or device model, and an email of a recipient associated with the recipient device.

17. The method of claim 16, further comprising receiving the type of device or device model from a communications service provider.

18. The method of claim 3, further comprising extracting the user data via software tools.

19. The method of claim 15, further comprising directly receiving user inputs comprising the user data.

20. A non-transitory computer readable medium on which are stored computer readable instructions and, when executed by a processor, cause the processor to:
receive an input comprising selection of an application for a transaction in connection with a recipient device, wherein the application is operable on one or more application platforms;
receive identifier information of the recipient device;
determine an application platform associated with the recipient device based at least in part on the identifier information of the recipient device; and
present the application platform associated with the recipient device.
